(19) United States
(12) Patent Application Publication
(10) Pub. No.: US 2021/0217081 A1
(43) Pub. Date: Jul. 15, 2021

(54) SYSTEM AND METHOD FOR EFFICIENTLY DELIVERING DATA TO TARGET USERS

(71) Applicant: Visa International Service Association, San Francisco, CA (US)

(72) Inventors: Abhishek Ravi, Singapore (SG); Francois Hribovsek, Singapore (SG); Wei Ying Yap, Singapore (SG)

(21) Appl. No.: 17/059,162

(22) PCT Filed: May 29, 2018
(86) PCT No.: PCT/US2018/034930

§ 371 Date: Nov. 25, 2020

(51) Int. Cl. G06Q 40/02; G06F 16/2457; G06Q 30/02; H04L 29/06

(52) U.S. Cl. CPC G06Q 40/025; H04L 63/104; G06Q 30/0201; G06F 16/24578

(57) ABSTRACT

A system and method are disclosed. The system and method can receive user data for a plurality of users from a plurality of data sources. The system can generate a plurality of scores for the plurality of users based on the user data. The system can further receive criteria and scoring parameters from a plurality of requesting entities. The system can determine a subset of users with scores that satisfy the criteria and scoring parameters. Further, the system can perform additional processing involving the subset of users.

### BACKGROUND

Users seeking products or services such as credit line increases, credit cards, loans, mortgages, refinancing, or other credit-based services and products apply to individual authorizing entities. Users applying to authorizing entities desire authorization and approval for a product or service. An authorizing entity can either approve or deny the user applicant for the requested product or service based on information provided by the applicant during the application process. The authorizing entity can base the approval or denial on additional applicant information not provided directly by the applicant, including credit scores, income level, total assets, credit history, and other criteria. This additional applicant-related information can be sourced from various data sources such as credit bureaus, telecommunications providers, banks, and other agencies that deal with financial and financially related information.

Often, to increase the chance of being approved for a product or service, an applicant will apply to multiple authorizing entities. The applicant will also typically apply to multiple authorizing entities to obtain the most desirable or beneficial product or service of a type of product or service. For example, an applicant may apply to several financial institutions seeking to compare available refinancing rates for a personal loan. Producing the required application information for each authorizing entity can be a time consuming process. To expedite the process, an applicant may not provide all the information that may help in being approved for the requested product or service. For example, an applicant may not disclose assets in a stock portfolio or 401k account. By not disclosing all relevant information, the applicant may not be approved for the desired rate or amount, or may be denied authorization of a product or service all together.

Further, each authorizing entity needs to make applicant data inquiries for each application submitted by every applicant. This can involve verifying the data submitted by the applicant as well as obtaining additional applicant data from multiple data sources. Requesting applicant information from multiple data sources can be a time consuming. As a result of an applicant applying for products and services provided by multiple authorizing entities in addition to each of those authorizing entities requesting data to make an authorization decision, arriving at an authorization decision can be a lengthy process. The application process can involve a number of transactions between different entities, applicants, and data sources, where a number of the transactions cannot be completed until previous transaction are completed (e.g., an authorizing entity may not send a response to an application until the authorizing entity has request data from a data source, the data source provides the applicant information to the authorizing entity, and the authorizing entity makes a determination based on the applicant information). Because of applicants' desire to compare available products and services that they qualify for, additional resources can be wasted when performing authorization decisions that are used for comparison purposes but are not accepted by applicants.

FIG. 1 shows a block diagram and a flow illustrating limitations of certain authorization and scoring system architectures for allowing a user to obtain product authorization from an authorizing entity, according to conventional systems and methods.

At step S130, a user 102 fills out an application and sends it to the authorizing entity 104. The user 102 can be a user that is interested in applying for products and services provided by an authorizing entity (e.g., issuer). The user 102 can provide the authorizing entity 104 with an application after discovering the authorizing entity 104. As such, a user 102 may often not be aware of other authorizing entities that can provide more competitive products and services.

Credit product application and scoring can be limited to a single user-to-authorizing entity relationship (e.g. a user applies to each authorizing entity). In the case of applying for credit products from different authorizing entities, multiple applications are submitted to the respective issuers. The authorizing entity 104 can perform an initial determination of whether the product or service requested by the user 102 is feasible (i.e., a request from the user 102 may not result in proceeding to step S132; e.g., the user 102 requests a $1,000,000 loan with no existing credit account and savings account (“CASA”) with the authorizing entity 104).

At step S132, the authorizing entity 104 processes the application provided by the user 102 and requests a credit check. The scoring engine 116 can process the request for the credit check, which can involve requesting credit scores from multiple credit reporting agencies.

At step S134, the scoring engine 116, in response to the request from the authorizing entity 104 in step S132, requests user data from the data source A 110, the data source B 112, and the data source C 114. The data source A 110, the data source B 112, and the data source C 114 can be various credit reporting agencies, telecommunications providers, social networks, or other entity that processes user specific data useful in determining financial standing. Once the scoring engine 116 receives feedback pertaining user data for the user 102, the scoring engine 116 can score and/or report the information to the authorizing entity 104.

In some examples, credit scoring is limited by the available connections of the authorizing entity 104 to various data sources. In markets with a sizeable unbanked, new-to-credit, and cash-heavy population, CASA and credit history data does not exist or is not comprehensive. Thus, requesting user data from the data source A 110, the data source B 112, and the data source C 114 may result in sparse or no user data on which to base an approval decision. In an attempt to resolve the sparsity of user data, the authorizing entity 104 may require the user 102 to download an application produced by a third-party credit-scoring provider or the authorizing entity 104 (e.g., an issuer). For each application the user 102 submits, the user 102 may be required to download a separate application simply to provide the authorizing entity 104 with sufficient accurate information.

At step S136, the scoring engine 116 reports the score attributed to the user 102 to the authorizing entity 104. The score can be individual scores received from each data source that was able to provide user data, or it can be an aggregate representation of the scores received from each data source (e.g., the data source A 110, the data source B 112, and the data source C 114).

At step S138, the authorizing entity 104 approves or denies the application of the user 102 based on the score provided by the scoring engine 116 at step S136. Often, an authorizing entity 104 can have a variety of products or services available to the user 102 depending on the eligibility of the user 102. However, assuming the application of the user 102 for a product is denied, the authorizing entity 104 may not recommend other products for which the user 102 may be eligible. As such, the user 102 would have to submit a second application to be provided with the other product for which the user 102 is eligible. For example, the user 102 may be denied a private loan at a low interest rate, but may be interested in and eligible for taking a loan out from the authorizing entity 104 against the mortgage of the user 102. The second inquiry to the multiple data sources corresponding to the second application may require requesting additional or different information than was requesting in the first application.

The entire approval process can include a minimum of five communications or transactions, assuming the scoring engine 116 only communicates with a single data source (e.g., steps 130 through 138). This consecutive linear approach to determining user eligibility for products and services offered by authorizing entities can be time consuming, and inaccurate due to lack of known user data.

Embodiments of the invention address these and other problems, individually and collectively.

### SUMMARY

Embodiments of the present invention provide for methods, devices, and systems for a central repository and scoring engine useable for reserving target users. According to some embodiments, a method is provided. The method comprises receiving, by a repository and scoring system, user data for a plurality of users from a plurality of data sources. The method further includes generating, by the repository and scoring system, a plurality of scores for the plurality of users. The method further comprises receiving, by the repository and scoring system, criteria and scoring parameters from a plurality of requesting entities. The method further includes determining, by the repository and scoring system, a subset of users with scores that satisfy the criteria and scoring parameters. The method additionally comprises performing, by the repository and scoring system, additional processing based on the subset of users.

Another embodiment of the invention is directed a repository and scoring system. The repository and scoring system can comprise a data processor, a network interface, and a non-transitory computer-readable medium including instructions that can be executable by the data processor. The non-transitory computer-readable medium can include instructions that can be executable by the data processor to receive, by the network interface, user data for a plurality of users from a plurality of data sources. The non-transitory computer-readable medium can further include instructions to generate a plurality of scores for the plurality of users. The non-transitory computer-readable medium can further include instructions to receive, by the network interface, criteria and scoring parameters from a plurality of requesting entities. Further, the non-transitory computer-readable medium can include instructions to determine a subset of users with scores that satisfy the criteria and scoring parameters. Additionally, the non-transitory computer-readable medium can further include instructions to perform additional processing based on the subset of users.

These and other embodiments of the invention are described in detail below. For example, other embodiments are directed to systems, devices, and computer readable media associated with methods described herein.

A better understanding of the nature and advantages of embodiments may be gained with reference to the following detailed description and the accompanying drawings.

### BRIEF DESCRIPTION OF THE DRAWINGS

FIG. 1 shows a block diagram illustrating limitations of certain authorization and scoring system architectures for allowing a user to obtain product authorization from an authorizing entity, according to an embodiment of the invention.

FIG. 2 shows a block diagram illustrating an authorization and scoring system architecture for allowing a user to obtain product authorization from multiple authorizing entities, according to one embodiment of the invention.

FIG. 3 shows a block diagram of a central repository and scoring engine system usable for allowing a user to obtain product authorization from multiple authorizing entities, according to one embodiment of the invention.

FIG. 4 shows a more detailed block diagram of FIG. 2 illustrating an authorization and scoring system architecture for allowing a user to obtain product authorization from multiple authorizing entities, according to one embodiment of the invention.

FIG. 5 shows a flow diagram of an exemplary method for allowing a user to obtain product authorization from multiple authorizing entities, according to one embodiment of the invention.

### DETAILED DESCRIPTION

Embodiments of the present invention provide for methods, devices, and systems for a central repository and scoring engine useable for reserving target users. In some embodiment, a centralized repository and scoring engine can receive user's credit scores from multiple data sources such as credit bureaus, credit players (e.g., Credolabs, Lenddo, etc.), transaction histories from merchants, and a variety of other user data in making eligibility decisions when offering or providing products or services to users. The central repository and scoring engine can be made available to issuers (e.g., requesting entities) via a standardized interface. Issuers can use the central repository and scoring engine to target users with particularized marketing, and to preapprove users for products or services. In other cases, the central repository and scoring engine may provide specific data such as access data or tokens to specific users.

According to an aspect of the present invention, embodiments for using a central repository and scoring engine to reserve target users are provided. The repository and scoring system can receive user data for a plurality of users from a plurality of data sources. Data sources (e.g., credit bureaus, telecommunications providers, banks, etc.) store and process both public and private user data that can be used to assess the risk associated with investing in or otherwise providing products or services to a user. The repository and scoring system can aggregate data from multiple data sources to provide a more complete picture of each user's financial standing. The repository and scoring system can generate a plurality of scores for the plurality of users. The central repository and scoring engine can determine a score for each user based on the user data received from the data sources. The user data attributed to a single user can be used to determine, by the central repository and scoring engine, a score for that single user, such that each user can be allocated an individualized score.

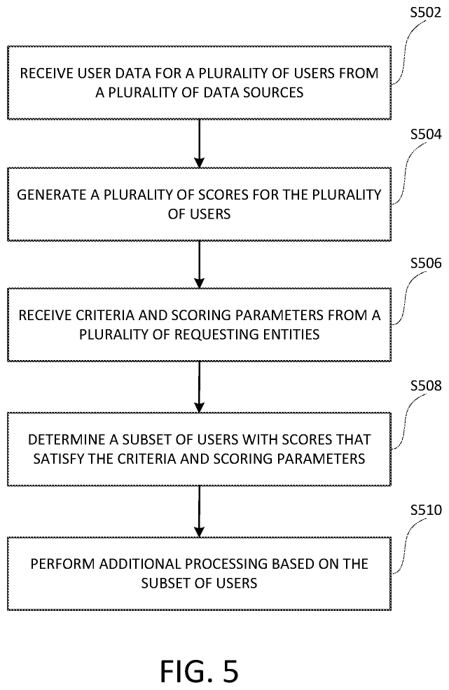

Further, the repository and scoring system can receive criteria and scoring parameters from a plurality of requesting entities. The criteria and scoring parameters can be used by the central repository and scoring engine to filter users based on their determined scores. Criteria and scoring parameters can include, for example, income level being greater than $75,000, or a credit account and savings account (“CASA”) ratio of a specific threshold level among other things. The repository and scoring system can determine a subset of users with scores that satisfy the criteria and scoring parameters. This way, the central repository and scoring engine can identify which of the users are eligible for certain specific data, products, or services offered by the requesting entities. The requesting entities can be notified of the identified eligible users by the central repository and scoring engine, and then produce personalized campaigns targeting individual users. In some embodiments, the requesting entities can also preapprove users for products and services, such that a user need only accept the offer to complete a transaction. Additionally, the repository and scoring system can perform additional processing, based on the subset of users. Additional processing that maybe performed by the repository and scoring system is further described by step S510 of FIG. 5.

The central repository and scoring engine can provide a solution to combine multiple data sources of credit scoring and make them available to multiple issuers. This can allow issuers to have a more comprehensive view of the potential user. Issuers can have the ability to reserve or preapprove users that the issuers want to target based on which user qualify for certain products and services. Multiple data sets derived from different data sources can be standardized and made available to issuers via APIs or batch files. In some embodiments, credit-scoring modules that parse user data can be seamlessly installed and run through SDKs in popular merchant applications, instead of users downloading separate applications required for applying to individual issuers.

As explained above, existing techniques can involve forcing a user to apply to each issuer with separate applications, each issuer then requesting and verifying data from multiple data sources. This tiered architecture can be time consuming, and a user's data can often not be fully disclosed or can be missing due to a lack of a centralized database that aggregates user data. Missing user data may result in a user not being eligible or approved for a product or service, where the user may otherwise be eligible if the issuers were provided with a complete picture of the user's financial standing and assets. Additionally, existing techniques can be slow since any request for user data is typically performed after the user initiates the process with an application. For example, a bank will request a credit check on a user from multiple credit reporting agencies after that user applies for a loan at that bank.

Embodiments can provide several advantages over existing techniques. For instance, a user (e.g., customer) may no longer have to initiate an application process with a specific issuer. For example, a user can submit a general authorization to use the services provided by the central repository and scoring engine without having to seek out individual issuers blindly. This can be helpful to both produce more competitive products and services among issuers in addition to making users aware of issuers who may not be popularly known. The user's application can make the user's data available for all issuers to see. A central repository and scoring engine can reduce the number of verification and authorization checks by acting as a central interface between users, data sources, and issuers.

Conventional techniques implement a linear architecture, whereas embodiments of the present invention implement a star architecture useable to increase the speed of the authorization and approval process. This can reduce the total number of communications required to approve a user for a product or service, therefore reducing the overall processing and costs associated in the application process. In some embodiments, the central repository and scoring engine can improve the overall success rate of marketing campaigns by advertising products and services to users who are interested in addition to being eligible. For example, issuers in existing limitations produce generalized marketing campaigns hoping to reach users who are interested and eligible for products and services. Many of the users who observe these campaigns are not interested, not eligible, or both. A central repository and scoring engine can pinpoint specific users to target, therefore improving the success rate of marketing campaigns and reducing costs associated with ineffective marketing. Also, in some instances, sensitive data such as access data or tokens can be provided to specific users that satisfy certain criteria for authorizing entities such as issuers.

Before discussing specific embodiments and examples, some descriptions of terms used herein are provided below.

A “repository and scoring system” may include a system capable of storing and scoring data. In one embodiment, the repository and scoring system can be used to receive user data from data sources and scoring parameters from requesting entities, generate scores for the user data, and determine which scores satisfy the scoring parameters. The repository and scoring system can be communicatively coupled with user devices, data sources, and requesting entities over a network or series of network (e.g., LAN, WAN, etc.) The repository and scoring system can be capable of storing data corresponding to a plurality of users, user devices, data sources, and requesting entities. In some examples, the repository and scoring system can be a single centralized server. In some examples, the repository and scoring system can be a group of servers communicatively coupled, such that the processes performed by the repository and scoring system are performed by multiple components housed in separate systems (e.g., multiple servers or computing devices, computing devices configured in a Cloud-based configuration, etc.). In some examples, the repository and scoring system may be referred to as a central repository and credit scoring system capable of determining a plurality of users' scores.

In some examples, the repository and scoring system can include a scoring engine. A scoring engine may take a user's stored history and risk features as inputs, and may output a score based on risk modeling performed in a transaction-processing network. A scoring engine can assess the score (e.g., risk) of a user based on the user data received from a user device and/or one or more data sources.

A “user” may include an individual. In some embodiments, a user may be associated with one or more personal accounts and/or mobile devices. The user may also be referred to as a cardholder, account holder, or consumer in some embodiments.

A “user device” may include a computing device operable by a user. Computing devices may include any device having a processor and a computer-readable medium. Many user devices are network-enabled devices that allow for remote communications over a communications network, such as the internet. A user device can also be a mobile device that is easily worn or carried by an individual, such as a smart phone, smart watch, or other wearable device. Other examples of user devices can include IOT (Internet of Things) devices, personal computers, laptops, PDAs, smart vehicles, smart televisions or any other machine or device capable of processing, receiving, transmitting, and storing data.

“User data” may include data corresponding to a user. User data can include data sourced from a user device or a data source. A repository and scoring system can utilize user data to determine one or more credit scores for one or more users. User data may include information related to determining credit scores of users. User data may include information related to a users' deposit and CASA (current and savings account) information, credit history, demographics, consumption, telecommunications, smart devices, social media, other assets, and psychometrics.

Deposit and CASA information may include any information associated with a user's account (e.g., a payment account and/or payment device associated with the account). Such information may be directly related to the account or may be derived from information related to the account. For example, user data relating to deposit and CASA information can include credit inflow and outflow, the number of accounts open, account balance, account activity, time active with bank(s), fund retention and attrition, internet and/or mobile banking activity, and corresponding branch information for each bank utilized by a user.

User data corresponding to credit history can include, for example, how new a user is to the credit, types of credit (e.g., mortgage, car payment plan, students loans, etc.), repayment history, credit amount and utilization, credit period, bankruptcy status, duration and existence of delinquency period, ability to be contacted or wage garnished in response to default or delinquency, and ease of credit collections. User data corresponding to demographics can include age, nationality, residence, marital status, education, criminal records, income, occupation, work habits, and job history. User data corresponding to consumption can include cost of rent, utilities, telecommunications services, insurance, other types of bills, and amount and frequency of online and offline shopping.

User data corresponding to telecommunications can include location of the telecommunication services, call and SMS history, internet browsing history, value-added services, top-up history, and mobile wallet transactions. User data corresponding to smart devices can include location of the smart device, call and SMS history, user contacts, storage use, applications, downloads, emails, calendar activities, images, audio, and videos consumed. User data corresponding to social media can include social network activities, communications, interests, and listed education and employment. User data corresponding to user assets can include home ownership, trust accounts, stock portfolios, and other investments and trading data.

A “data source” may include a source that contains data. A data source may be used to store user data and communicate the stored use data with a repository and scoring system. A data source may be a server or series of servers used to store information including user data. A data source can be communicatively coupled to one or more devices (e.g., repository and scoring system) for which the devices source or receive data from the data source. For example, data sources can be credit bureaus or reporting agencies (e.g., Experian, Equifax, TransUnion, FICO), telecommunications providers, smart devices, social networks, banks, or any other entity or device that has access to user data related to credit scoring.

A “score” may include a value used in a system of ratings. In some examples, scores can be allocated to individual users amongst a group of users. A score can include a fraud score corresponding to a certain level of risk. A score may be in any suitable form. The score may be numeric or may be based upon letters. A score can be a discrete value, and can be based upon other scores.

In some examples, a score may be based in part on one or more credit scores included in user data. For example, a user may be associated with various reportable credit scores (e.g., 675, 720, 690). These credit scores, along with other user data, can be used by the repository and scoring system to generate a new customized score (e.g., a score from 0 to 100). In some examples, the score generated by the repository and scoring system can be on a scale similar to existing credit reporting scales (e.g., 350 to 850). A score may have any suitable form. For example, a score can range from values of 1 to 100, where 1 may be associated with a high fraud risk or debt and 100 may be associated with a low fraud risk or debt.

In some examples, a score may be associated with one or more sub-scores. A sub-score may correspond to additional user data inquired by requesting entities for purposes of more precisely determining user risk level. A score may be generated based on various sub-scores. For example, a user may have separate sub-scores corresponding to bank account amounts and transaction history (e.g., a score based in part on asset utilization), a sub-score rating social media activity (e.g., a score based in part on publically known employment data), and another sub-score relating to fraud risk based on demographics (e.g., a score based in part on age, location, etc.). The bank account and transaction sub-score, the social media sub-score, and the demographic sub-score can be used in the generation of an overall score, where the overall score can represent the overall risk of a user. For example, a user may be attributed a score of 80 out of 100 generated by the repository and scoring system based on user data. The user may also have a sub-score where, for example, income level can be used as a factor to determine the sub-score (e.g., the sub-score is based in part on a user's income level, where a higher income can correspond to a higher sub-score and a lower income can correspond to a lower sub-score). In this example, the sub-score may be a value based on a user income level of $75,000. The user may satisfy the criteria and scoring parameters of one requesting entity that requests only the overall score (e.g., the requesting entity requires a score of 65). As another example, the same user may not satisfy the criteria and scoring parameters of another requesting entity that requests the overall score and the sub-score relating to income level (e.g., the requesting entity requires a score of 65 and a sub-score that is a value correlating to an income level of $100,000).

“Criteria and scoring parameters” may include any suitable information that serves as data point useable for measurement purposes. In some examples, criteria and scoring parameters can be generated by one or more requesting entities for risk assessment purposes (i.e. determining if a user satisfies certain criteria). A repository and scoring system can be used to compare criteria and scoring parameters against the scores for one or more users to determine if certain users qualify for products and/or services offered by the requesting entities. A requesting entity may develop criteria and scoring parameters with various thresholds pertaining to user data. For example, criteria and scoring parameters may include thresholds for income level, credit scores as reported by a specific credit bureau, total debt, and other distinguishable data points included within user data. In some examples, scoring parameters may include threshold levels for various sub-scores of a user's overall score. For example, a requesting entity may set a social media scoring parameter of 50 out of 100 to filter users with social media sub-scores of less than 50.

A “requesting entity” may include an entity that requests information. In some examples, a requesting entity can be an authorizing entity that authorizes a request. Examples of an authorizing entity may be an issuer, a governmental agency, a document repository, an access administrator, etc. A requesting entity can generate one or more tokens related to sensitive data (e.g., preapproval and offer of credit line increase on a credit card, loan, refinancing rates, etc.).

A “subset of users” may include a group of users that are part of a set of users. A subset of users can have distinguishable features from the larger group of users of which the subset of users is included. For example, a subset of users can include users who satisfy criteria and scoring parameters defined by a plurality of requesting entities. Users not within the subset of users may not satisfy the criteria and scoring parameters.

“Additional processing” may include processing that may be executed in addition to executing one or more other processes.

A “token” may include a substitute identifier for some information. A token may be a string of numbers, letters, or any other suitable characters. Examples of tokens include payment tokens, access tokens, personal identification tokens, etc. For example, an access token may include an identifier for accessing an account that is a substitute for an account identifier, such as a primary account number (PAN). For instance, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers. The token may also be used to represent the original credential in other systems where the original credential would typically be provided. In some embodiments, a token value may be generated such that the recovery of the original PAN or other account identifier from the token value may not be computationally derived.

In some embodiments, upon successful identification of a specific user, an access token may be generated and sent to a device operated by a user. The access token can be used by the user to gain access to resources provided by a resource providing entity.

A “module” may include any component or sub-component of a system. For example, a module may include a software program configured to perform a particular function when executed by a processor.

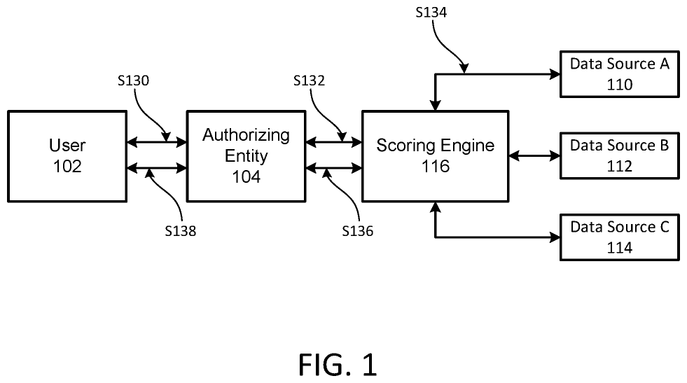

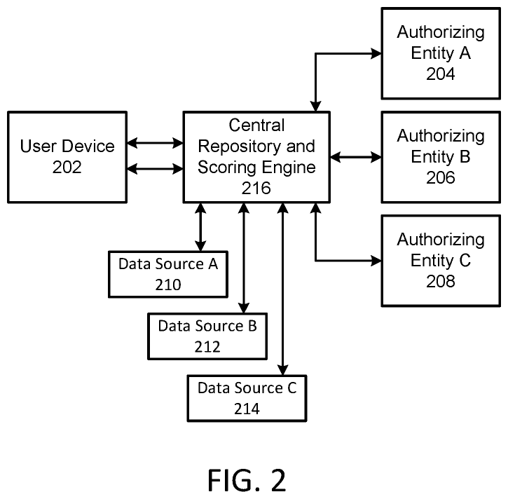

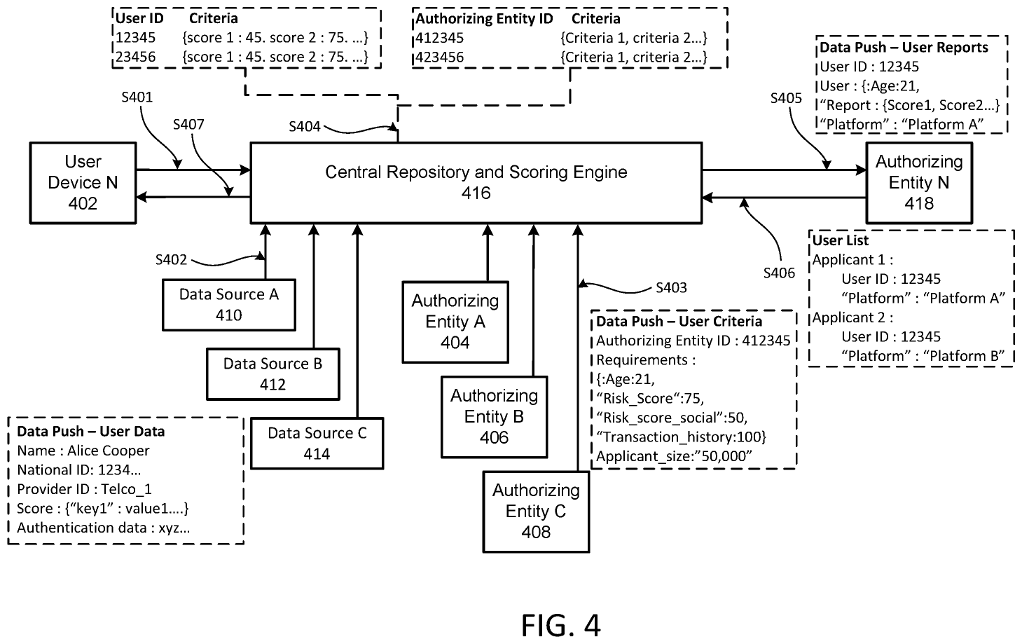

FIG. 2 shows a block diagram illustrating an authorization and scoring system architecture for allowing a user to obtain product authorization from multiple authorizing entities, according to one embodiment of the invention. The processes and architecture described in FIG. 2 are described in more detail herein with respect to FIG. 4. As compared to the existing system for allowing a user to obtain product authorization from an authorizing entity as described in FIG. 1, FIG. 2 depicts an architecture for a star configuration. The central repository and scoring engine 216 provides for a more efficient method for providing users with more pinpointed targeted advertisements and/or preapproved products and services.

The central repository and scoring engine 216 can receive inputs corresponding to user data for multiple users from the data source A 210, the data source B 212, and the data source C 214. Additional information regarding receiving user data from data sources may be found below in reference to step S402 of FIG. 4. The central repository and scoring engine 216 can receive criteria and scoring parameters from the authorizing entity A 204, the authorizing entity B 206, and the authorizing entity C 208. Additional information regarding receiving criteria and scoring parameters from authorizing entities may be found below in reference to step S403 of FIG. 4.

The central repository and scoring engine 216 can determine a score for each user based on the input received from the data source A 210, the data source B 212, and the data source C 214. Utilizing the scores for each user, the central repository and scoring engine 216 can determine which of the users satisfy the criteria and scoring parameters. The central repository and scoring engine 216 can match eligible users to the authorizing entity A 204, the authorizing entity B 206, and the authorizing entity C 208 for purposes of reserving users. Additional information regarding generating a score for each user and matching users to authorizing entities may be found below in reference to step S404 of FIG. 4. A user reserved by the authorizing entity A 204, the authorizing entity B 206, or the authorizing entity C 208 can be targeted, via user device 202, with advertisements for products or services for which the user is eligible. A reserved user can also be preapproved for and authorized to receive, via user device 202, a product or service provided by the authorizing entity A 204, the authorizing entity B 206, or the authorizing entity C 208. A reserved user can also be allowed to receive access data or a token.

In some embodiments, the aforementioned operations may occur prior to a user making a request or submitting an application via a user device 202. For example, before the user device 202 submits an application, the central repository and scoring engine 216 can (i) receive user data from the data source A 210, the data source B 212, and the data source C 214, (ii) receive criteria and scoring parameters from the authorizing entity A 204, the authorizing entity B 206, and the authorizing entity C 208, then (iii) determine a list of users eligible for various products and services. In some examples, these processes can occur concurrently, such that the central repository and scoring engine 216 can continue to (i) receive new or updated user data, (ii) receive new or updated criteria and scoring parameters, (iii) score and match users with authorizing entities, and (iv) provide users with targeted advertisements or preapproval of products or services.

Certain embodiments can provide for a new credit scoring flow that can expand the potential user's single application to multiple issuers through a data push configuration, as opposed to the data pull configuration described by existing techniques in FIG. 1. The central repository and scoring engine 216 can allow multiple authorizing entities to access multiple data sources through a single connection.

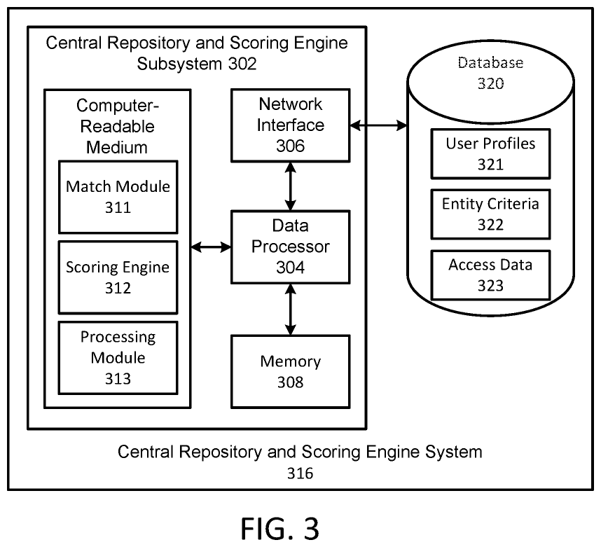

FIG. 3 shows a block diagram of a central repository and scoring engine system usable for allowing a user to obtain product authorization from multiple authorizing entities, according to one embodiment of the invention. The central repository and scoring engine system 316 can include a central repository and scoring engine subsystem 302 and a database 320. The central repository and scoring engine subsystem 302 can be used to perform any of the processes for allowing a user to obtain product authorization from multiple authorizing entities described herein.

The central repository and scoring engine subsystem 302 can include a data processor 304, a network interface 306, a memory 308, and a computer-readable medium 310 that are connected via a bus. In some examples, the components shown in FIG. 3 (e.g., the data processor 304, the network interface 306, the memory 308, the computer-readable medium 310, and the database 320) can be integrated into a single structure. For example, the components can be within a single housing. In other examples, the components shown in FIG. 3 can be distributed (e.g., in separate housings) and in electrical communication with each other. In other examples, the database 320 can be a separate component distinct from the central repository and scoring engine system 316 and remotely located (e.g., the database 320 stores data remotely via third-party servers, or in a Cloud-based configuration).

The data processor 304 can execute one or more operations for implementing some examples. The data processor 304 can execute instructions stored in the memory 308 and the computer-readable medium 310 to perform the operations. The data processor 304 can include one processing device or multiple processing devices. Non-limiting examples of the data processor 304 include a Field-Programmable Gate Array (“FPGA”), an application-specific integrated circuit (“ASIC”), a microprocessor, etc.

The data processor 304 can be communicatively coupled to the memory 308 via a bus. The non-volatile memory 308 may include any type of memory device that retains stored information when powered off. Non-limiting examples of the memory 308 include electrically erasable and programmable read-only memory (“EEPROM”), flash memory, or any other type of non-volatile memory. In some examples, at least some of the computer-readable medium 310 can include a medium from which the data processor 304 can read instructions. A computer-readable medium can include electronic, optical, magnetic, or other storage devices capable of providing the data processor 304 with computer-readable instructions or other program code. Non-limiting examples of a computer-readable medium include (but are not limited to) magnetic disk(s), memory chip(s), ROM, random-access memory (“RAM”), an ASIC, a configured processor, optical storage, or any other medium from which a computer processor can read instructions. The instructions can include processor-specific instructions generated by a compiler or an interpreter from code written in any suitable computer-programming language, including, for example, C, C++, C#, etc.

The database 320 can store user profiles 321, entity criteria 322, and access data 323. The user profiles 321 can store user data received from data sources, login information required to access the central repository and scoring engine system 316, status of any ongoing or successful approvals, record of authorizing entities and products for which the user is eligible, or any other data required for a user to complete the approval processes described herein. The entity criteria 322 can include any criteria and scoring parameters (e.g., income level of at least $50,000, age of at least 25, active card status of at least 5 years, etc.) submitted by authorizing entities to the central repository and scoring engine system 316. The database 320 can store the entity criteria 322 separately based on authorizing entity and the product or service being offered. The access data 323 can include any information to perform any authorization process, as further described by step S510 of FIG. 5 (e.g., tokens, access data such as passwords or one-time passwords, etc.).

The computer-readable medium 310 can include program code for a match module 311, a scoring engine 312, and a processing module 313.

The processing module 313 of the central repository and scoring engine subsystem 302 may include any code, application, or any other software module configured to cause the central repository and scoring engine system 316 to control the network interface 306 to interface with an antenna or other communications hardware. Any other suitable communication networks, protocols, and hardware may be used. The network interface 306, in conjunction with the data processor 304, can communicate with any devices, systems, or apparatuses to receive information necessary from entities (e.g., data sources, user devices, authorizing entities, database 320) for implementing some processes.

The scoring engine 312 may include any application, code, and/or any other software configured to cause the central repository and scoring engine system 316 to allocate a score to a user based on user data received from various data sources. The match module 311 may include any application, code, and/or any other software configured to cause the central repository and scoring engine system 316 to match a user with a product or service provided by an authorizing entity. The match module 311, in conjunction with the data processor 304, can use the score determined by the scoring engine 312 to determine if a user is eligible a variety of products or services The processing module 313 may include any application, code, and/or any other software configured to perform any operations not performed by the match module 311 and the scoring engine 312. In some examples, the processing module 313, in conjunction with the data processor 304, can provision a token or access to a user device via the network interface 306, so that the user device can access a specific resource (e.g., goods or services, access to locations, access to restricted data, etc.).

FIG. 4 shows a more detailed block diagram of FIG. 2 and illustrates an authorization and scoring system architecture for allowing a user to obtain product authorization from multiple authorizing entities according to one embodiment of the invention. In some embodiments, the central repository and scoring engine 416 can include a standardized application program interface (API) to implement the processes described herein more easily.

At step S401, a user operating the user device N 402 submits an application to the central repository and scoring engine 416 seeking products and services for which the user is eligible. The user device N 402 can represent any number of user devices operated by any number of users (e.g., user device 1, user device 2, user device 3, etc.). The central repository and scoring engine 416 can be configured transmit and/or receive communications to and/or from multiple user devices at any given instance.

In some examples, the application submitted by the user device N 402 can provide authorization to the central repository and scoring engine 416 to allow the central repository and scoring engine 416 to access private data (e.g., bank accounts, trading portfolios, etc.) corresponding to the user operating the user device N 402. In some examples, the central repository and scoring engine 416 can, in response to receiving an application, request authorization from the user device N 402 to access private user data. The authorization provided by the user device N 402 can provide the central repository and scoring engine 416 with permission to begin requesting, receiving, and storing user data from various data sources according to step S402. In some examples, the application can include user account information useable to access user profiles and user accounts stored on various data sources.

In some embodiments, the user application and/or user request submitted to the central repository and scoring engine 416 by the user device N 402 can include user data. The user data may be pertinent in determining a score as described by step S404. For example, an application submitted by a user via user device N 402 may include identification information, such as name, date of birth, social security number (SSN), or any other data that may be used to identify an individual.

In some embodiments, step S401 may occur after steps S402 through S406 are performed. As such, the central repository and scoring engine 416 can reduce the time for the user device N 402 to receive preapprovals and/or targeted advertisements (i.e. the central repository and scoring engine 416 can prepare a list of advertisements and preapproved products or services before a user makes a request or submits an application).

At step S402, the central repository and scoring engine 416 receives user data for a plurality of users. The central repository and scoring engine 416 can receive user data corresponding to a plurality of users from the data source A 410, the data source B 412, and the data source C 414 (e.g., credit bureaus or reporting agencies, telecommunications providers, smart devices, social networks, banks, etc.). User data may include data inputs that can be used to determine a score of a user according to the processes described in step S404. More data sources than the data source A 410, the data source B 412, and the data source C 414 can exist. The data source A 410, the data source B 412, and the data source C 414 are non-limiting examples of data sources shown to depict that the central repository and scoring engine 416 can be in communication with multiple data sources at any given instance. For example, with the data source A 410 can be a bank, the data source B 412 can be a social media entity, and the data source C 414 can be a telecommunications company. The central repository and scoring engine 416 can communicate with each data source simultaneously to receive a user's CASA information from the bank, employment information from the social media entity, and utility information from the telecommunications company.

The central repository and scoring engine 416 can match the user data provided by the user device N 402 in step S401 with user data provided by the data source A 410, the data source B 412, and the data source C 414. User data provided by the user device N 402 can be matched with user data provided by various data sources using a user identification (“ID”) number. For example, the user device N 402 may correspond to a user ID of the user operating the user device N 402. User data provided by each data source can include the same or similar user ID. In some examples, the central repository and scoring engine 416 can generate a user ID based on information conventionally used to identify a user (e.g., name, SSN, date of birth, etc.). Based on identifying information received by the central repository and scoring engine 416 in conjunction with user data, the central repository and scoring engine 416 can generate the same user ID for user data received from the user device N 402 and each data source. After determining the user ID for each set of user data, the central repository and scoring engine can match user data for a single user received from the user device N 402 and each data source. In other examples, the user ID can be any format such as a national ID format (e.g., SSN), where the user device N 402, the data source A 410, the data source B 412, and the data source C 414 store and transmit the national ID format with or included as part of the user data.

For example, the central repository and scoring engine 416 can correlate a user and the user's application data (e.g., name, SSN, request for particular services, etc.) with credit score information provided by a credit bureau and employment data provided by a social network account. By linking the user data provided in step S401 with the user data provided by the data source A 410, the data source B 412, and the data source C 414 using a user ID, the central repository and scoring engine 416 can accumulate a more complete record of data inputs that may affect a user's score as determined in step S404. Linking a user identity with additional user data can reduce the time required to provide the user device N 402 with products or services if or when provisioning the user device N 402 with access data in step S407.

In some embodiments, the data source A 410, the data source B 412, and the data source C 414 can push user data to the central repository and scoring engine 416 without being prompted by a request message from the central repository and scoring engine 416. In other embodiments, the central repository and scoring engine 416 can request large batch files of user data or user data corresponding to individual users from the data source A 410, the data source B 412, and the data source C 414.

In some embodiments, the data source A 410, the data source B 412, and the data source C 414 can continually push new or updated user data to the central repository and scoring engine 416. Pushing new or updated user data to the central repository and scoring engine 416 in predetermined intervals or upon receipt of the new or updated user data can allow the central repository and scoring engine 416 to provide more accurate user scores in real time. Pushing user data to the central repository and scoring engine 416 can reduce the amount of time it may take to provide a user with products and services offered by authorizing entities.

At step S403, the central repository and scoring engine 416 receives criteria and scoring parameters from a plurality of authorizing entities (e.g., an issuer, a governmental agency, a document repository, an access administrator, etc.). The authorizing entity A 404, the authorizing entity B 406, and the authorizing entity C 408 can transmit distinct criteria and scoring parameters (e.g., income level, debt, credit activity, age, employment status, etc.) to the central repository and scoring engine 416. The submitted criteria and scoring parameters can be used in step S404 to determine which users are eligible for various products and services provided by the authorizing entity A 404, the authorizing entity B 406, and the authorizing entity C 408.

An authorizing entity can be an entity that authorizes a request made by an entity such as a user. For example, the authorizing entity A 404 can be a bank that offers mortgage loans, the authorizing entity B 406 can be a refinancing agency offering reduced loan rates, and the authorizing entity C 408 can be a governmental program offering welfare benefits. In other examples, the authorizing entity A 404, the authorizing entity B 406, and the authorizing entity C 408 may be in a same line of business offering competing products. The authorizing entity A 404, the authorizing entity B 406, and the authorizing entity C 408 are non-limiting examples of authorizing entities shown to depict that the central repository and scoring engine 416 can be in communication with multiple authorizing entities at any given instance.

The central repository and scoring engine 416 can store the criteria and scoring parameters corresponding to separate products and services for each authorizing entity. For example, the authorizing entity A 404 may have a line of credit cards that the authorizing entity A 404 wants to offer to users with an income above $80,000 and a credit utilization of less than 25%. The central repository and scoring engine 416 can receive these criteria and scoring parameters to filter eligible users in step S404. As another example, the authorizing entity B 406 may have a similar line of credit cards to offer users with similar criteria and scoring parameters. However, the authorizing entity B 406 may have a credit card from the line of credit cards that requires a user to meet a higher threshold credit-utilization ratio of 35%. As such, the central repository and scoring engine 416 can separately store (e.g., in database 320 of FIG. 3) three instances of criteria and scoring parameters for: (i) the credit card line of authorizing entity A 404, (ii) the credit card line of authorizing entity B 406, and (iii) the higher credit utilization value corresponding to the card from the credit card line of authorizing entity B 406.

In some embodiments, the authorizing entity A 404, the authorizing entity B 406, and the authorizing entity C 408 can push criteria and scoring parameters to the central repository and scoring engine 416 without being prompted by a request message from the central repository and scoring engine 416. In other embodiments, the central repository and scoring engine 416 can request criteria and scoring parameters from the authorizing entity A 404, the authorizing entity B 406, and the authorizing entity C 408.

At step S404, the central repository and scoring engine 416 generates scores for a plurality of users and determines a subset of users with scores that satisfy the criteria and scoring parameters. The central repository and scoring engine 416 can generate a score for each user based on the user data received in steps S401 and S402. The central repository and scoring engine 416 can determine which users are eligible for certain products and services by comparing the user scores against the criteria and scoring parameters (e.g., income level, age, CASA ratio, credit card utilization, employment status, etc.).

A generated score can include or be linked with any user data or sub-parameters that may be useful for filtering eligible users. The score may include sub-scores pertaining to various aspects of a user's life (e.g., social media sub-score, trading portfolio sub-score, credit score sub-score, etc.). In some examples, a sub-score can be linked with a corresponding score such that the score may be used to represent a user's overall risk and the sub-score can represent one or more factors contributing to the overall risk. Sub-scores may be communicated along with an overall score so that the central repository and scoring engine 416 can filter users based on their overall score and various sub-scores. This can allow an authorizing entity to filter users based on an overall score representing user risk, while retaining the ability to filter users based on more specific criteria represented by the sub-scores.

For example, the central repository and scoring engine 416 may generate a user score of 80 out of 100 based on the user data, the score representing the user's overall risk, and a social media sub-score of 25 out of 100. A low score or sub-score may represent a higher investment risk associated with a user, and a higher score or sub-score may represent a lower investment risk associated with a user. In this example, the user score may be high based on good credit history, but the social media sub-score may be low if, for example, the user's social media account lists the user as unemployed. Authorizing entity A 404 may have criteria and scoring parameters for a product line set at a threshold level of 85 for an overall score and 20 for a social media sub-score. Authorizing entity B 406 may have criteria and scoring parameters for a product line set at a threshold of 75 for an overall score and 40 for a social media sub-score. Authorizing entity A 404 may have criteria and scoring parameters for a product line set at a threshold level of 75 for an overall score, and may set no restrictions based on social media sub-scores.

By filtering users based on specific criteria and scoring parameters, the central repository and scoring engine 416 can reduce the number of transactions required to determine if a user is eligible and subsequently provision access data to the user device N 402. For example, embodiments of the invention can eliminate the need for an authorizing entity to request user data from various data sources, wait for the request to be fulfilled, then make a determination of user eligibility based on the received user data (e.g., as described in FIG. 1). The central repository and scoring engine 416 preemptively filters ineligible users so that the authorizing entity N 418 is only provided with eligible users as described in step S405.

Still referring to the previous example, the user would not satisfy the criteria and scoring parameters of the authorizing entity A 404 or the authorizing entity B 406, but would satisfy the criteria and scoring parameters of the authorizing entity C 408. As such, the central repository and scoring engine 416 can determine that the user satisfies the criteria and scoring parameters of the authorizing entity C 408 and store the user and corresponding user data as being eligible for the particular product or service. The central repository and scoring engine may store this information pertaining to the eligibility of the user separately or as an item within a list of eligible users.

In some embodiments, a score can be dynamically updated when new user data is received. Referring to the previous example, the user may choose to update the social media account to change the listed employment status from unemployed to employed with a certain company. The data source storing this information can push the updated data to the central repository and scoring engine 416, and the central repository and scoring engine 416 can update the stored user profile with this new information. Because employment status may be relevant in determining a user's score, the central repository and scoring engine 416 can generate a new score and sub-scores based on the change. For example, the central repository and scoring engine may generate a new score of 87 and a social media sub-score of 75 based on the updated employment status. The central repository and scoring engine 416 can then determine that the user would satisfy the criteria and scoring parameters of the authorizing entity A 404, the authorizing entity B 406, and the authorizing entity C 408. Updating scores dynamically in response to a change in data inputs as opposed to in response to a manual request or submitted application from the user device N 402 can reduce the time to provide users with targeted products and services.

At step S405, the central repository and scoring engine 416 transmits a set of eligible user records to the authorizing entity N 418. The authorizing entity N 418 can be any authorizing entity that has previously submitted criteria and scoring parameters according to the process described in step S403. The authorizing entity N 418 can represent any number of authorizing entities communicatively coupled to the central repository and scoring engine 416 (e.g., the authorizing entity A 404, the authorizing entity B 406, the authorizing entity C 408, etc.). The authorizing entity N 418 can store the set of eligible user records.

The set of eligible user records can include any number of users who satisfy criteria and scoring parameters according to the processes described in step S404. In some embodiments, a user from the set of eligible users may be eligible for one product offered by the authorizing entity N 418, but not eligible for another product offered by the authorizing entity N 418. For example, a user may qualify for one credit card, but may not qualify for a more restrictive premium credit card. In some examples, the set of eligible user records can be updated dynamically by the central repository and scoring engine 416 and resent to the authorizing entity N 418 when a previously ineligible user becomes eligible for a product or service. Similarly, the set of eligible user records can be updated dynamically by the central repository and scoring engine 416 and resent to the authorizing entity N 418 when a previously eligible user becomes ineligible for a product or service.

At step S406, the authorizing entity N 418 reserves users from the set of user records and transmits a list of reserved users to the central repository and scoring engine 416. The authorizing entity N 418 can reserve users to designate which users from the set of user records to target for specific products or services. In some examples, the authorizing entity N 418 may not reserve all eligible users listed in the set of users records received from the central repository and scoring engine 416. Although a number of users may be eligible to receive offers for products and services, the authorizing entity N 418 may want to limit the number of offers. For example, the authorizing entity N 418 may determine that it is economically feasible to offer a limited time credit card deal to 1,000 users from an eligible user list containing more than 1,000 users.

In some examples, the transmission to the central repository and scoring engine 416 comprising the reserved user list may include additional information related to the offer for which the users are eligible. For example, the transmission by the authorizing entity N 418 may include access or authorization data to allow the user to access sensitive information (e.g., login or account information to view or accept personalized offers).

In some embodiments, the access data provided by the authorizing entity N 418 can include a token. The token may be instantly issued to a user. For example, when a user becomes eligible for a credit card offered by an authorizing entity, the user can be preapproved for the new payment card. Subsequently, tokens associated with the new payment card offer can be provisioned to the user device N 402. A token may be provisioned automatically to a user device N 402 in response to user satisfying criteria and scoring parameters. For example, a user can satisfy criteria and scoring parameters and a token can be issued to the user device N 402 without prompting the authorizing entity N 418 for approval of the token issuance.

In some examples, the authorizing entity N 418 may be communicatively coupled to the user device N 402 to provision the token directly to the user device N 402 in step S406. In other examples, the authorizing entity N 418 may transmit the token to the central repository and scoring engine 416 to forward to the user device N 402. In some examples where the central repository and scoring engine 416 has been granted authorization and the required information from the authorizing entity N 418, the credit repository and scoring engine 416 can generate a token in response to determining that a user is an eligible user. The credit repository and scoring engine 416 can provision the token to the user device N 402.

It the user device N 402 has a token, it may be used to conduct an access transaction such as a payment transaction or access transaction. The user would use the user device N 402 and interact with an access device such as a terminal in a transaction. The terminal would generate an authorization request message including the token to the authorizing entity. The authorizing entity or another entity affiliated with the authorizing entity can resolve the token to an underlying real credential (e.g., a real account number) and can approve of the transaction based upon the real credential. The use of the token keeps the real credential from being compromised in transit.

At step S407, in some embodiments, the central repository and scoring engine 416 can provide the user device N 402 with an offer for products or services. In some examples, the user operating the user device N 402 can be preapproved for the offered products and services. As such, the communication from the central repository and scoring engine 416 notifying the user device N 402 of the products and services can include access data required to accept the preapproved offer. As noted above, in some examples, the access data can include an access token used to access sensitive data. The user can be provisioned with the access data via the user device N 402.

After being provisioned with access data, the user may take any number of appropriate actions (e.g., viewing the information, accepting or declining terms for a product or service, creating an account with the authorizing entity N 418, providing additional user data, etc.).

In some embodiments, the user device N 402 may run a website or application hosted by the authorizing entity N 418. In some cases, the user may indicate to the application or website to utilize a provisioned token from an authorizing entity or the central repository and scoring engine 416 for a transaction. In other cases, information related to the token may be pre-filled by the application or website. The user may then conduct the transaction with the authorizing entity using the provisioned token. As a result, the new account can be utilized to conduct a transaction with the authorizing entity instantly after issuance. For example, a user device can be provisioned with a token instantly. Instant token issuance can be used to provide an additional level of security while provisioning data to the user device N 402.

In some examples, step S407 can include providing the user device N 402 with an advertisement. The advertisement can be provided to user device N 402 in a number of medium including on social media, on a merchant website, in a streaming video service, etc. The advertisement can be the result of the user satisfying an authorizing entity's criteria and scoring parameters. For example, if a user is eligible for products or services as described by the processes in steps 401 through 406, the user may be provided with one or more advertisements approved by one or more authorizing entities. The advertisement may include offers for credit cards, lines of credit, and other products and services that the user may be approved for instantly. If a user satisfies criteria and scoring parameters for one authorizing entity but not another, the user would be provided with advertisements from the matched authorizing entity and not the authorizing entity whose criteria the user does not meet.

In some examples, an authorizing entity can be an online merchant utilizing the central repository and scoring engine 416. An online merchant can use the central repository and scoring engine 416 and various modules and components described in FIG. 3 to provision access data to the user device N 402. The central repository and scoring engine 416 can be implemented within a payment network. In some examples, an online merchant can be configured as a pass-through interface (e.g., the online merchant relays information to and from a central repository and scoring engine that is acting as a stand-alone system.).

Further describing the example with an online merchant, at step S405, the online merchant can receive the subset of users that satisfy criteria and scoring parameters from the central repository and scoring engine 416. The online merchant can then forward the list to the authorizing entity N 418. At step S406, the online merchant can receive a list of selected users reserved by the authorizing entity N 418, and then forward the list of selected users to the central repository and scoring engine 416. At step S407, the online merchant can relay data, including tokens to access secure data, from the central repository and scoring engine 416 to the user device N 402. In some examples, the online merchant can interface directly between the user device N 402 and the authorizing entity N 418 when performing steps S406 and S407, bypassing the central repository and scoring engine 416. This can reduce the processing steps required to be performed by the central repository and scoring engine 416 to provide the user device N 402 with offers and preapprovals for products or services.

The procedures of step S407 may be executed in response to the procedures of step S401. For example, the user device N 402 can submit a request to the central repository and scoring engine 416 for loan rates for a specified loan amount according to step S401. The central repository and scoring engine 416 may perform steps S402 through S406 in response to the request, or may have preemptively performed steps S402 through S406. In response to the request described by step S401 the central repository and scoring engine 416 can provide the user device N 402 with various loan rates offered by the authorizing entity A 404, the authorizing entity B 406, and/or the authorizing entity C 408.

In some examples, the processes described by steps 401 through 407 can be performed in any order or in concurrence with each other. In some examples, steps 401 through 406 can be performed independently of step S407. A user can submit an application or request in step S401, and steps S402 through S406 can be performed in preparation of step S407. For example, a user may submit an application, be given a score by the central repository and scoring engine 416, and be reserved by the authorizing entity N 418. However, the user operating user device N 402 may not be in a position to receive the offer for products or services at step S407 (e.g., the user device N 402 is disabled, the user is not currently operating user device N 402, etc.). When the user next operates the user device N 402, step S407 may be performed to provide the user with an offer for products or services provided by the authorizing entity N 418. As such, steps 401 through 406 can be performed in preparation of step S407 to reduce overall time to approve and/or preapprove users for products and services.

In other examples, steps S402 through S406 may be performed independently of steps S401 and S407. Steps S402 through S406 can be performed without first being prompted by the user application or request received by central repository and scoring engine 416 from the user device N 402. Thus, a user can be preapproved for products or services prior to making a request or submitting an application. For example, the central repository and scoring engine 416 can store profiles on potential users where user data is publically available.

FIG. 5 shows a flow diagram of an exemplary method for allowing a user to obtain product authorization from multiple authorizing entities, according to one embodiment of the invention.

At step S502, the repository and scoring system receives user data for a plurality of users from a plurality of data sources. A user may provide user data to the repository and scoring system via a user device. The repository and scoring system can receive additional user data from multiple data sources. Additional information regarding receiving user data from data sources may be found above in reference to step S402 of FIG. 4.

At step S504, the repository and scoring system generates plurality of scores for the plurality of users. Each user of the plurality of users can be designated an individualized score based on the user data received by the repository and scoring system in step S502. Additional information regarding generating a score for each user and matching users to authorizing entities may be found above in reference to step S404 of FIG. 4

At step S506, the repository and scoring system receives criteria and scoring parameters from a plurality of requesting entities. The repository and scoring system can receive eligibility criteria for various products and services for purposes of determining user eligibility in step S508. Additional information regarding receiving criteria and scoring parameters from authorizing entities may be found above in reference to step S403 of FIG. 4.

At step S508, the repository and scoring system determines a subset of users with scores that satisfy the criteria and scoring parameters. The subset of users who satisfy the criteria and scoring parameters of the requesting entities can be identified for purposes of performing additional processes according to step S510. Additional information regarding determining a subset of users with scores that satisfy the criteria and scoring parameters may be found above in reference to step S404 of FIG. 4.

At step S510, the repository and scoring system performs additional processing based on the subset of users. The subset of users can be a group of users reserved by one or more requesting entities (e.g., authorizing entities). Additional information regarding performing additional processing may be found above in reference to the steps described in FIG. 4 generally, and disclosed below.

In some embodiments, additional processing can include transmitting, by the repository and scoring system, at least some of the user data for the subset of users to one or more of the requesting entities. The repository and scoring system can transmit user data to the requesting entities for purposes of the requesting entities making decisions on which of the users who satisfy criteria and scoring parameters can be selected to receive information such as access tokens or access data, or can be targeted by products or services offered by the requesting entities.

Additional processing can include receiving, by the repository and scoring system, identification of one or more selected users of the subset of users from one or more of the requesting entities of the plurality of requesting entities, and then performing more processing based upon the received identification information. The requesting entities can receive a selection of users or a list generated by the requesting entities that can inform the repository and scoring system which users of the subset of users are to be offered products or services, or are to receive access data, tokens, or other information.

According to some embodiments, additional processing can include provisioning, by the repository and scoring system, access data or tokens to one or more communication devices operated by the subset of users. The access data could be a password or code that can be used by a user to gain access to restricted information or a restricted location. The token may be used by the user to conduct an access transaction such as a payment transaction.

Additional processing can include allowing, by the repository and scoring system, the subset of users to access sensitive data corresponding to one or more of the requesting entities of the plurality of requesting entities. The repository and scoring system can initialize and transmit messages comprising access data to user devices, the messages including sensitive data relating to viewing and accepting products or services provided by requesting entities (i.e. the sensitive content of the message can be accessed by a user via the access data). For example, the access data provisioned by the repository and scoring system can allow a user to access individualized offers that may include private user information (e.g., an offer for lower rates may depict a comparison between the user's current rate and rates calculated by a requesting entity).

It should be understood that any of the embodiments of the present invention can be implemented in the form of control logic using hardware (e.g. an application specific integrated circuit or field programmable gate array) and/or using computer software with a generally programmable processor in a modular or integrated manner. As used herein, a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted to be prior art.

What is claimed is:

1. A method comprising:
receiving, by a repository and scoring system, user data for a plurality of users from a plurality of data sources;
generating, by the repository and scoring system, a plurality of scores for the plurality of users;
receiving, by the repository and scoring system, criteria and scoring parameters from a plurality of requesting entities;
determining, by the repository and scoring system, a subset of users with scores that satisfy the criteria and scoring parameters; and
performing, by the repository and scoring system, additional processing based on the subset of users.

2. The method of claim 1, wherein the requesting entities are authorizing entities.

3. The method of claim 1, wherein performing additional processing includes transmitting at least some of the user data to one or more of the requesting entities.

4. The method of claim 1, wherein performing additional processing includes initiating provisioning access data to one or more communication devices operated by the subset of users, the access data allowing the subset of users to access restricted data.

5. The method of claim 1, wherein performing additional processing includes allowing the subset of users to access sensitive data.

6. The method of claim 1, wherein the user data includes user identification information for the plurality of users, wherein the user identification information for each user of the plurality of users is useable to match user data from the plurality of data sources for each user.

7. The method of claim 1, wherein generating the plurality of scores for the plurality of users further includes generating the plurality of scores for the plurality of users based on the user data.

8. The method of claim 1, wherein performing additional processing includes receiving identification of one or more selected users of the subset of users from one or more of the requesting entities of the plurality of requesting entities.

9. The method of claim 1, wherein the criteria and scoring parameters from the plurality of requesting entities includes different criteria and scoring parameters for each requesting entity of the plurality of requesting entities.

10. The method of claim 1, wherein performing additional processing includes initiating provisioning tokens to one or more communication devices operated by the subset of users.

11. A system comprising:
a data processor;
a network interface coupled to the data processor; and
a non-transitory computer-readable medium including instructions executable by the data processor to:
receive, by the network interface, user data for a plurality of users from a plurality of data sources;
generate a plurality of scores for the plurality of users;
receive, by the network interface, criteria and scoring parameters from a plurality of requesting entities;
determine a subset of users with scores that satisfy the criteria and scoring parameters; and
perform additional processing based on the subset of users.

12. The system of claim 11, wherein the requesting entities are authorizing entities.

13. The system of claim 11, wherein performing additional processing includes transmitting at least some of the user data to one or more of the requesting entities.

14. The system of claim 11, wherein performing additional processing includes initiating provisioning access data to one or more communication devices operated by the subset of users, the access data allowing the subset of users to access restricted data.

15. The system of claim 11, wherein performing additional processing includes allowing the subset of users to access sensitive data.

16. The system of claim 11, wherein the user data includes user identification information for the plurality of users, wherein the user identification information for each user of the plurality of users is useable to match user data from the plurality of data sources for each user.

17. The system of claim 11, wherein generating the plurality of scores for the plurality of users further includes generating the plurality of scores for the plurality of users based on the user data.

18. The system of claim 11, wherein performing additional processing includes receiving identification of one or more selected users of the subset of users from one or more of the requesting entities of the plurality of requesting entities.

19. The system of claim 11, wherein the criteria and scoring parameters from the plurality of requesting entities includes different criteria and scoring parameters for each requesting entity of the plurality of requesting entities.

20. The system of claim 11, wherein performing additional processing includes initiating provisioning tokens to one or more communication devices operated by the subset of users.
